(19) United States
(12) Patent Application Publication
(10) Pub. No.: US 2015/0089487 A1
(43) Pub. Date: Mar. 26, 2015

(54) TERMINAL SOFTWARE MAINTENANCE METHOD, SERVICE CLIENT AND SERVICE SERVER

(71) Applicant: Tencent Technology (Shenzhen) Company Limited, Shenzhen (CN)

(72) Inventor: Xin Liu, Shenzhen (CN)

(73) Assignee: Tencent Technology (Shenzhen) Company Limited

(21) Appl. No.: 14/565,054

(22) Filed: Dec. 9, 2014

Related U.S. Application Data
(63) Continuation of application No. PCT/CN2013/077168, filed on Jun. 13, 2013.

(30) Foreign Application Priority Data
Jun. 14, 2012 (CN) 201210195832.4

(51) Int. Cl. G06F 9/445; G06F 21/57

(52) U.S. Cl. CPC G06F 8/65; G06F 21/577; G06F 2221/033
USPC 717/168

(57) ABSTRACT

Disclosed are a terminal software maintenance method, a service client, and a service server. The method comprises: the service client acquires software information of a terminal on the basis of a software maintenance triggering instruction from the terminal, and submits to the service server; and, the service server compares the software information submitted by the service client with pre-stored software information, and feeds back the comparison result to the service client for display. The present invention prompts a user, on the basis of the maintenance instruction corresponding to the user, as to which software in the terminal requires maintenance, maintains the software that requires maintenance via the service client, and improves on an existing software maintenance solution, thus preventing virus intrusion and ensuring system operation security and terminal user performance.

### CROSS-REFERENCES TO RELATED APPLICATIONS

The present application claims the priority and is a continuation of PCT/CN2013/077168, filed on Jun. 13, 2013 and entitled “TERMINAL SOFTWARE MAINTENANCE METHOD, SERVICE CLIENT AND SERVICE SERVER”, which claims the priority to Chinese Patent Application No. 201210195832.4, entitled “TERMINAL SOFTWARE MAINTENANCE METHOD, SERVICE CLIENT AND SERVICE SERVER”, filed on Jun. 14, 2012 with the Chinese State Intellectual Property Office, which are incorporated herein by reference in their entireties.

### FIELD

The disclosure relates to the field of the technology for maintaining terminal software.

### BACKGROUND

Vulnerability generally refers to a defect of a logic design for hardware, software and a protocol. Due to the defect, an attacker may access a system without authorization, leading to loss of information in a computer and even a damage to the system. Therefore, in order to ensure the safe operation of the system of a terminal, the software of the terminal is required to be updated and maintained in a real time manner.

### SUMMARY

A method for maintaining terminal software, a service client and a service server thereof are provided in the disclosure, to solve at least one of the above problems.

According to the disclosure, it is provided a method for maintaining terminal software, including:

acquiring, by a service client, software information of a terminal based on a software maintenance triggering instruction from the terminal, and submitting the software information of the terminal to a service server; and

comparing, by the service server, the software information submitted by the service client with pre-stored software information to generate a comparison result, and feeding back the comparison result back to the service client for display.

The step of acquiring, by the service client, software information of a terminal based on a software maintenance triggering instruction from the terminal includes:

searching, by the service client, for an add/uninstall option in a control panel of the terminal, based on the software maintenance triggering instruction, to acquire the software information of the terminal.

The software maintenance triggering instruction includes at least one of a vulnerability scan triggering instruction and a software upgrade triggering instruction.

The step of comparing the software information submitted by the service client with the pre-stored software information to generate a comparison result, and feeding back the comparison result to the service client for display, includes:

comparing, by the service server, the software information submitted by the service client with the pre-stored information of software having a vulnerability or required to be upgraded; and

feeding back the comparison result to the service client in the case that the comparison result indicates that software having vulnerability or required to be upgraded corresponds to the software information submitted by the service client, to prompt a user for information of the software having vulnerability or required to be upgraded in the terminal by the service client.

The method further includes:

receiving, by the service client, a vulnerability fixing instruction or a software upgrading instruction from the terminal; and

fixing or upgrading the software having vulnerability or required to be upgraded based on the vulnerability fixing instruction or the software upgrading instruction.

According to the disclosure, it is also provided a system for maintaining terminal software, including a service client and a service server, where

the service client is configured to acquire software information of a terminal based on a software maintenance triggering instruction from the terminal, submit the software information of the terminal to the service server, and display a comparison result fed back by the service server; and

the service server is configured to compare the software information submitted by the service client with pre-stored software information to generate the comparison result, and feed back the comparison result to the service client.

The service client is further configured to search for an add/uninstall option in a control panel of the terminal based on the software maintenance triggering instruction, to acquire the software information of the terminal.

The software maintenance triggering instruction includes at least one of a vulnerability scan triggering instruction and a software upgrade triggering instruction.

The service server is further configured to compare the software information submitted by the service client with the pre-stored information of software having vulnerability or required to be upgraded and generate the comparison result, and feed back the comparison result to the service client in the case that the comparison result indicates that software having vulnerability or required to be upgraded corresponds to the software information submitted by the service client, to prompt a user for information of the software having vulnerability or required to be upgrade in the terminal by the service client.

The service client is further configured to fix or upgrade the software having vulnerability or required to be upgraded based on a vulnerability fixing instruction or a software upgrading instruction from the terminal.

According to the disclosure, it is also provided a service client for maintaining terminal software, including:

an acquiring and submitting module configured to acquire software information of a terminal based on a software maintenance triggering instruction from the terminal, and submit the software information of the terminal to a service server;

a result receiving module configured to receive a comparison result fed back by the service server, where the comparison result is generated by comparing the software information with the pre-stored software information by the service server; and

a result display module configured to display the comparison result fed back by the service server.

The service client further includes an instruction receiving module, where the instruction receiving module is configured to receive the software maintenance triggering instruction from the terminal.

The software maintenance triggering instruction includes at least one of a vulnerability scan triggering instruction and a software upgrade triggering instruction.

The instruction receiving module is configured to receive a vulnerability fixing instruction or a software upgrading instruction from the terminal;

the service client further includes a fixing module, configured to fix or upgrade software having a vulnerability or required to be upgraded based on the vulnerability fixing instruction or the software upgrading instruction.

In the technical solution provided in the disclosure, the service client acquires the software information of the terminal based on the software maintenance triggering instruction from the terminal, and submits the software information of the terminal to the service server, the service server compares the software information submitted by the service client with the pre-stored software information to be maintained to generate the comparison result, and feeds back the comparison result to the service client for display. In this way, the user is prompted that which software in the terminal has vulnerability or is required to be upgraded, and maintains the software required to be maintained is through the service client, an existing software maintenance solution is improved, thus preventing virus intrusion and ensuring security of system operation and terminal use performance.

### BRIEF DESCRIPTION OF THE DRAWINGS

FIG. 1 is a schematic flow chart of a method for maintaining terminal software according to a first embodiment of the invention;

FIG. 2 is a schematic flow chart of a method for maintaining terminal software according to a second embodiment of the invention;

FIG. 3 a schematic structural diagram of a system for maintaining terminal software according to a third embodiment of the invention;

FIG. 4 is a schematic structural diagram of a service client for maintaining terminal software according to a fifth embodiment of the invention;

FIG. 5 is a schematic structural diagram of a service client for maintaining terminal software according to a sixth embodiment of the invention; and

FIG. 6 is a schematic structural diagram of a service client for maintaining terminal software according to a seventh embodiment of the invention.

Objects, functional features and advantages of the disclosure will be further illustrated in conjunction with embodiments with reference to accompanying drawings.

### DETAILED DESCRIPTION

It should be understood that the embodiments described here are merely intended to interpret the disclosure, and not intended to limit the disclosure.

The technical solution provided in the embodiments of the invention includes that a service client acquires software information of a terminal based on a software maintenance triggering instruction from the terminal, and submits the software information of the terminal to a service server, the service server compares the software information submitted by the service client with pre-stored software information to generate a comparison, and feeds back the comparison result to the service client for displaying the comparison result to a user. In this way, the user is prompted that which software in the terminal is required to be maintained, and the software is maintained through the service client, an existing software maintenance solution is improved, thus preventing virus intrusion and ensuring security of system operation and terminal use performance.

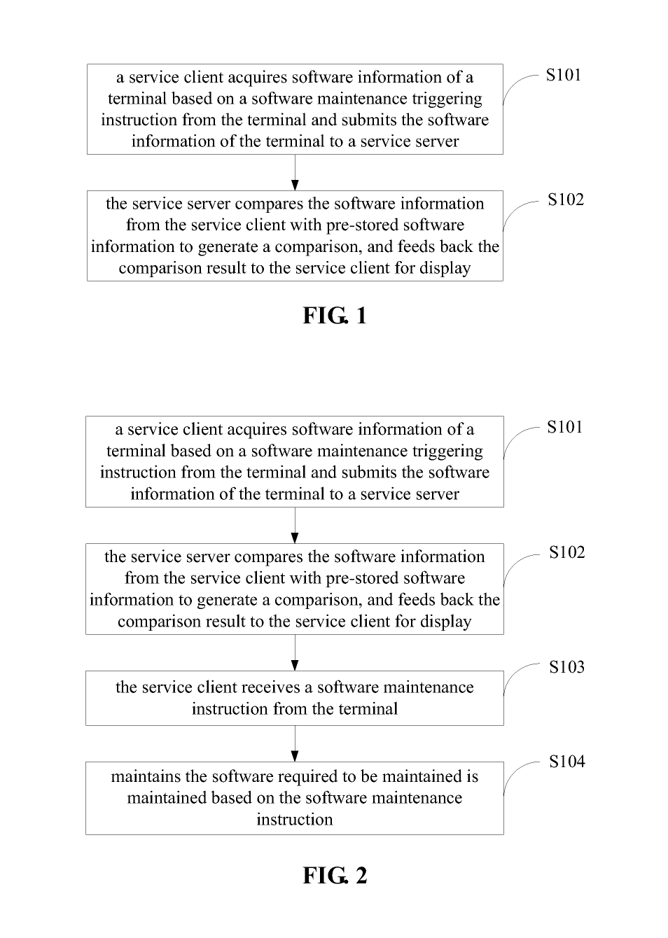

As shown in FIG. 1, a method for maintaining terminal software is provided in a first embodiment of the invention, which includes steps S101 to S102.

Step S101 may include a service client acquiring software information of a terminal based on a software maintenance triggering instruction from the terminal and submitting the software information of the terminal to a service server.

In the embodiment, an application carried by the service client may be software installed on the terminal, and has an operation interface on the terminal. The software maintenance triggering instruction may be sent to the service client through the operation interface on the terminal; the software maintenance triggering instruction may be a vulnerability scan triggering instruction, a software upgrade triggering instruction or other corresponding software maintenance instruction. In the embodiment, scanning or fixing software vulnerability is taken as an example to illustrate.

The service client acquires the software information of the terminal based on a vulnerability scan instruction from the terminal, and submits the acquired software information to the service server by means of listing.

The service client may acquire the software information of the terminal in the following manner: the software information is acquired by searching for an add/uninstall option in a control panel of the terminal. The software information includes a software name, a version number and a production company, i.e.

Step S102 may include the service server comparing the software information from the service client with pre-stored software information to generate a comparison, and feeding back the comparison result to the service client for display.

In the embodiment, software information of software having vulnerability, such as a name, a version and a production company of the software, are stored and recorded in advance by the service server.

After receiving the software information submitted by the service client, the service server compares the software information submitted with the pre-stored information of the software having vulnerability to generate a comparison result. The service server feeds back the comparison result to the service client in a case that the comparison result indicates that the software having vulnerability corresponds to the software information submitted by the service client. The service client prompts the user the information of the software having vulnerability in the terminal, that is, the user is informed that which software in the terminal has vulnerability, to facilitate performing a corresponding fix processing, preventing virus intrusion and ensuring security of system operation.

In the embodiment, scanning vulnerability scan the software of the terminal is taken as an example, to illustrate maintenance operation to the software. Although fixing vulnerability for the software may be to uninstall the software or upgrade the software to the latest version, the solution described above may also be applied in a scenario in which the software does not have vulnerability, for example, it may be required for the user to know that which software in the terminal is required to be upgraded or uninstalled, to perform maintenance operation such as upgrading or unloading the software, which is not exemplified here.

In the solution of the embodiment described above, the user may be prompted that which software in the terminal is required to be maintained, for example, which software has vulnerability, thus improving the existing software maintenance solution, preventing virus intrusion or ensuring security of system operation.

As shown in FIG. 2, another method for maintaining terminal software is provided in a second embodiment of the invention, the difference between the second embodiment and the first embodiment is that the method in second embodiment further includes steps S103 to S104 after step S102 described above.

Step S103 may include the service client receiving a software maintenance instruction from the terminal.

In the second embodiment, the software maintenance instruction may be a vulnerability fixing instruction or a software upgrading instruction.

Step S104 may include maintaining the software required to be maintained based on the software maintenance instruction.

In the second embodiment, software having vulnerability or required to be upgraded is fixed or upgraded by the service client based on the vulnerability fixing instruction or the software upgrading instruction.

Compared with the first embodiment, the method in the second embodiment further includes a step in which the software required to be maintained on the terminal is maintained by the service client.

For example, the vulnerability fixing instruction or the software upgrading instruction is sent to the service client through the terminal, in the case that the user is informed that that the software having vulnerability or required to be upgraded exists on the terminal through the display of the service client, the service client fixes or upgrades the software having vulnerability or required to be upgraded based on the vulnerability fixing instruction or the software upgrading instruction.

With the solution of the embodiment described above, the user may be prompted which software in the terminal is required to be maintained, and maintains the software through the service client, such as fixes the software having vulnerability, or upgrades software. Thus improving the existing software maintenance solution, preventing virus intrusion in a more comprehensive way, and ensuring security of system operation and terminal use performance.

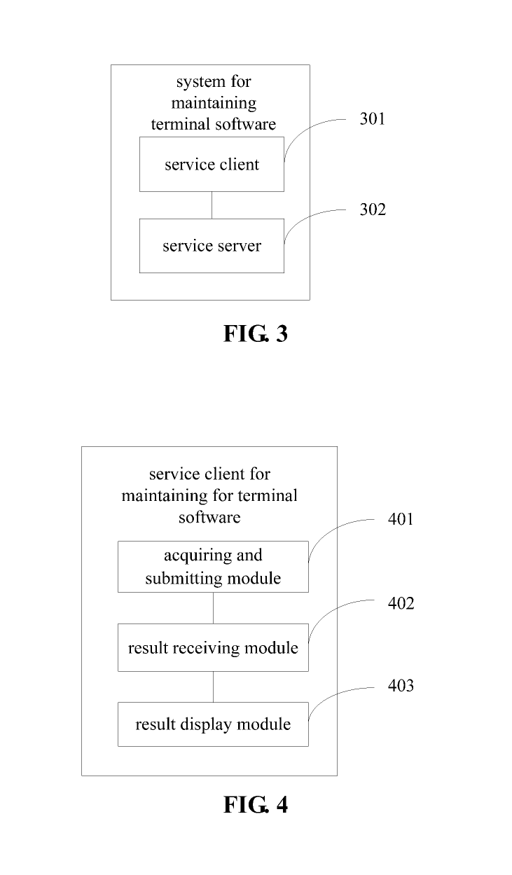

As shown in FIG. 3, a system for maintaining terminal software is provided in a third embodiment of the invention, which includes: a service client 301 and a service server 302.

The service client 301 is configured to acquire software information of a terminal based on a software maintenance triggering instruction from the terminal, submit the software information of the terminal to the service server 302, receive a comparison result fed back by the service server 302, and display the comparison result.

The service server 302 is configured to compare the software information from the service client 301 with pre-stored software information to generate a comparison result, and feed back the comparison result to the service client 301.

In the embodiment, an application carried by the service client 301 may be software installed on the terminal, and has an operation interface on the terminal. The software maintenance triggering instruction may be sent to the service client 301 through the operation interface on the terminal; the software maintenance triggering instruction may be a vulnerability scan triggering instruction, a software upgrade triggering instruction or other corresponding software maintenance instruction. In the embodiment, scanning and fixing software vulnerability is taken as an example to illustrate.

The service client 301 acquires the software information of the terminal based on the vulnerability scan instruction from the terminal, and submits the acquired software information to the service server 302 by means of listing.

The service client 301 may acquire the software information of the terminal in the following manner: the software information is acquired by searching for an add/uninstall option in a control panel of the terminal. The software information includes a software name, a version number and a production company, i.e.

The software information of software having vulnerability, such as a name, a version and a production company of the software, are stored and recorded in advance by the service server 302.

After receiving the software information submitted by the service client 301, the service server 302 compares the software information submitted with the pre-stored information of the software having vulnerability to generate a comparison result. The service server 302 feeds back the comparison result to the service client 301 in a case that the comparison result indicates that the software having vulnerability corresponds to the software information submitted by the service client 301. The service client 301 prompts the user information of the software having vulnerability in the terminal, that is, the user is informed that which software in the terminal has vulnerability, to facilitate performing a corresponding fix processing, preventing virus intrusion and ensuring security of system operation.

In the embodiment, scanning vulnerability for the software of the terminal is taken as an example, to illustrate maintenance operation to the software. Although fixing vulnerability for the software may be to uninstall the software or upgrade the software to the latest version, the solution described above may also be applied in a scenario in which the software does not have vulnerability, for example, it may be required for the user to know that which software in the terminal is required to be upgraded or uninstall, to perform maintenance operation such as upgrading or unloading the software, which is not exemplified here.

In the solution of the embodiment described above, the user may be prompted which software in the terminal is required to be maintained, for example, which software has vulnerability, thus improving the existing software maintenance solution, preventing virus intrusion or ensuring security of system operation.

Another system for maintaining terminal software is provided in a fourth embodiment of the invention, and compared with the third embodiment, a service client 301 is further configured to receive a software maintenance instruction from the terminal, and maintain software required to be maintained based on the software maintenance instruction.

In the embodiment, the software maintenance instruction may be a vulnerability fixing instruction or a software upgrading instruction. For example, the vulnerability fixing instruction or the software upgrading instruction is sent to the service client 301 through the terminal, in the case that the software having vulnerability or required to be upgraded exists on the terminal through the display of the service client 301, the service client 301 fixes or upgrades the software having vulnerability or required to be upgraded based on the vulnerability fixing instruction or the software upgrading instruction.

In the solution of the embodiment described above, the user may be prompted that which software in the terminal is required to be maintained, and maintains the software required to be maintained through the service client 301, such as fixes the software having vulnerability, or upgrades software upgrade. Thus improving the existing software maintenance solution, preventing virus intrusion, and ensuring security of system operation and terminal use performance.

As shown in FIG. 4, a service client for maintaining terminal software is provided in a fifth embodiment of the invention, which includes an acquiring and submitting module 401, a result receiving module 402 and a result display module 403.

The acquiring and submitting module 401 is configured to acquire software information of a terminal based on a software maintenance triggering instruction from the terminal, and submit the software information of the terminal to a service server.

The result receiving module 402 is configured to receive a comparison result fed back by the service server, where the comparison result is generated by comparing the software information is compared with pre-stored software information by the service server.

The result display module 403 is configured to display the comparison result fed back by the service server.

In the embodiment, an application carried by the service client may be software installed on the terminal, and has an operation interface on the terminal. The software maintenance triggering instruction may be sent to the service client through the operation interface on the terminal; the software maintenance triggering instruction may be a vulnerability scan triggering instruction, a software upgrade triggering instruction or other corresponding software maintenance instruction. In the embodiment, scanning or fixing software vulnerability is taken as an example to illustrate.

The acquiring and submitting module 401 of the service client acquires the software information of the terminal based on the vulnerability scan instruction from the terminal, and submits the acquired software information to the service server by means of listing.

The acquiring and submitting module 401 of the service client may acquire the software information of the terminal in the following manner: the software information is acquired by searching for an add/uninstall option in a control panel of the terminal. The software information includes a software name, a version number and a production company, i.e.

In the embodiment, software information of software having vulnerability, such as a name, a version and a production company of the software, are stored and recorded in advance by the service server.

After receiving the software information submitted by the service client, the service server compares the software information submitted with the pre-stored information of the software having vulnerability to generate a comparison result. The service server feeds back the comparison result to the result receiving module 402 of the service client in a case that the comparison result indicates that the software having vulnerability corresponds to the software information submitted by the service client. The result display module 403 of the service client prompts the user information of the software having vulnerability in the terminal, that is, the user is informed that which software in the terminal has vulnerability, to facilitate performing a corresponding fix processing, preventing virus intrusion and ensuring security of system operation.

In the embodiment, scanning vulnerability for the software of the terminal is taken as an example, to illustrate maintenance operation to the software. Although fixing vulnerability for the software may be to uninstall the software or upgrade the software to the latest version, the solution described above may also be applied in a scenario in which the software does not have vulnerability, for example, it may be required for the user to know that which software in the terminal is required to be upgraded or uninstalled, to perform maintenance operation such as upgrading or unloading the software, which is not exemplified here.

In the solution of the embodiment described above, the user may be prompted which software in the terminal is required to be maintained, for example, which software has vulnerability, thus improving the existing software maintenance solution, preventing virus intrusion or ensuring security of the system operation.

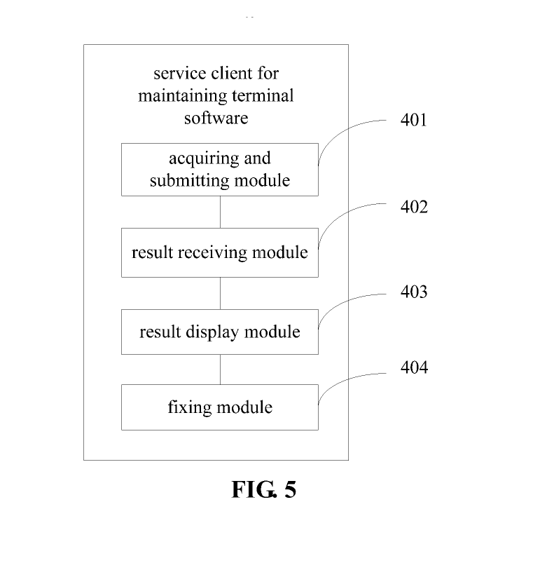

As shown in FIG. 5, a service client for maintaining terminal software is provided in a sixth embodiment of the invention, and compared with the fifth embodiment, the service client in the sixth embodiment further includes a fixing module 404.

The fixing module 404 is configured to maintain software required to be maintained based on a received software maintenance instruction.

The difference between the sixth embodiment and the fifth embodiment is that the service client in the sixth embodiment further includes the fixing module which maintains the software required to be maintained on the terminal is maintained. In the embodiment, scanning or fixing software vulnerability is taken as an example to illustrate.

The vulnerability fixing instruction or the software upgrading instruction is sent to the service client through the terminal, in the case that the user is informed that the software having vulnerability or required to be upgraded exists on the terminal through the display of the service client, the fixing module 404 of the service client fixes or upgrades the software having vulnerability or required to be upgraded based on the vulnerability fixing instruction or the software upgrading instruction.

In the solution of the embodiment described above, the user may be prompted that which software in the terminal is required to be maintained, and maintains the software required to be maintained through the service client. Thus improving the existing software maintenance solution, preventing virus intrusion, and ensuring security of system operation and terminal use performance.

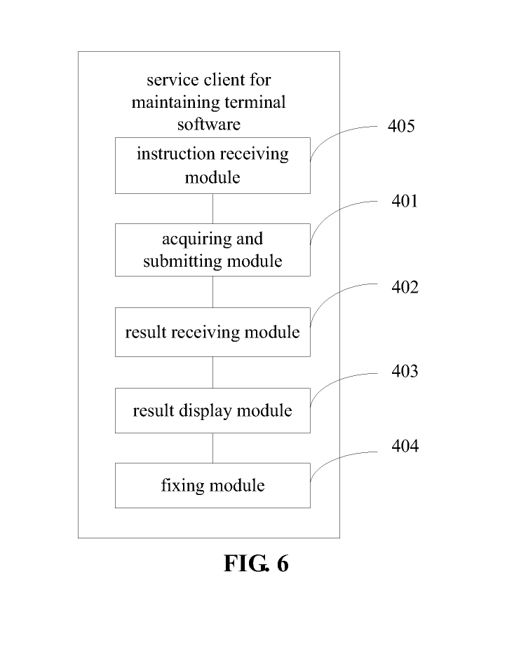

As shown in FIG. 6, a service client maintaining terminal software is provided in a seventh embodiment of the invention, and compared with the sixth embodiment, the service client in the seventh embodiment further includes an instruction receiving module 405.

The instruction receiving module 405 is configured to receive a software maintenance triggering instruction from a terminal.

In the embodiment, upon reception of the software maintenance triggering instruction from the terminal, the instruction receiving module 405 sends the software maintenance triggering instruction to the acquiring and submitting module 401. The acquiring and submitting module 401 acquires the software information of the terminal based on the software maintenance triggering instruction, and submits the software information of the terminal to the service server.

In addition, the instruction receiving module 405 is further configured to receive a terminal software maintenance instruction.

In the embodiment, upon reception of the terminal software maintenance instruction, the instruction receiving module 405 sends the terminal software maintenance instruction to the fixing module 404, and the fixing module 404 maintains the software required to be maintained based on the received software maintenance instruction.

The foregoing are only preferred embodiments of the invention and therefore are not intended to limit the scope of the invention, and any equivalent structures or equivalent alternatives made based on the description and the accompanying drawings of the invention, as well as any applications made based on the disclosure which are directly or indirectly applied to other related technical field are all included in the scope of protection of the present invention.

1. A method for maintaining terminal software, comprising:
acquiring, by a service client, software information of a terminal based on a software maintenance triggering instruction from the terminal, and submitting the software information of the terminal to a service server; and
comparing, by the service server, the software information submitted by the service client with pre-stored software information to generate a comparison result, and feeding back the comparison result to the service client for display.

2. The method according to claim 1, wherein acquiring, by a service client, software information of a terminal based on a software maintenance triggering instruction from the terminal comprises:
searching, by the service client, for an add/uninstall option in a control panel of the terminal, based on the software maintenance triggering instruction, to acquire the software information of the terminal.

3. The method according to claim 1, wherein the software maintenance triggering instruction comprises at least one of a vulnerability scan triggering instruction and a software upgrade triggering instruction.

4. The method according to claim 3, wherein comparing the software information submitted by the service client with the pre-stored software information to generate a comparison result, and feeding back the comparison result to the service client for display, comprises:
comparing, by the service server, the software information submitted by the service client with the pre-stored information of software having a vulnerability or required to be upgraded; and
feeding back the comparison result to the service client in the case that the comparison result indicates that software having vulnerability or required to be upgraded corresponds to the software information submitted by the service client, to prompt a user for information of the software having vulnerability or required to be upgraded in the terminal by the service client.

5. The method according to claim 4, further comprising:
receiving, by the service client, a vulnerability fixing instruction or a software upgrading instruction from the terminal; and
fixing or upgrading the software having vulnerability or required to be upgraded based on the vulnerability fixing instruction or the software upgrading instruction.

6. A system for maintaining terminal software, comprising a service client and a service server, wherein
the service client is configured to acquire software information of a terminal based on a software maintenance triggering instruction from the terminal, submit the software information of the terminal to the service server, and display a comparison result fed back by the service server; and
the service server is configured to compare the software information submitted by the service client with pre-stored software information to generate the comparison result, and feed back the comparison result to the service client.

7. The system according to claim 6, wherein the service client is further configured to search for an add/uninstall option in a control panel of the terminal based on the software maintenance triggering instruction, to acquire the software information of the terminal.

8. The system according to claim 6, wherein the software maintenance triggering instruction comprises at least one of a vulnerability scan triggering instruction and a software upgrade triggering instruction.

9. The system according to claim 6, wherein the service server is further configured to compare the software information submitted by the service client with the pre-stored information of software having vulnerability or required to be upgraded and generate the comparison result, and feed back the comparison result to the service client in the case that the comparison result indicates that software having vulnerability or required to be upgraded corresponds to the software information submitted by the service client, to prompt a user for information of the software having vulnerability or required to be upgrade in the terminal by the service client.

10. The system according to claim 9, wherein the service client is further configured to fix or upgrade the software having vulnerability or required to be upgraded based on a vulnerability fixing instruction or a software upgrading instruction from the terminal.

11. A service client for maintaining terminal software, comprising:
an acquiring and submitting module configured to acquire software information of a terminal based on a software maintenance triggering instruction from the terminal, and submit the software information of the terminal to a service server;
a result receiving module configured to receive a comparison result fed back by the service server, wherein the comparison result is generated by comparing the software information with the pre-stored software information by the service server; and
a result display module configured to display the comparison result fed back by the service server.

12. The service client according to claim 11, further comprising an instruction receiving module,
wherein the instruction receiving module is configured to receive the software maintenance triggering instruction from the terminal.

13. The service client according to claim 12, wherein the software maintenance triggering instruction comprises at least one of a vulnerability scan triggering instruction and a software upgrade triggering instruction.

14. The service client according to claim 13, wherein the instruction receiving module is configured to receive a vulnerability fixing instruction or a software upgrading instruction from the terminal;
the service client further comprises a fixing module, configured to fix or upgrade software having a vulnerability or required to be upgraded based on the vulnerability fixing instruction or the software upgrading instruction.
